(19) United States
(12) Patent Application Publication
(10) Pub. No.: US 2009/0276473 A1
(43) Pub. Date: Nov. 5, 2009

(54) METHOD AND APPARATUS FOR MAINTAINING CONSISTENCY BETWEEN DATABASE AND VIRTUAL TABLE

(76) Inventors: Mari Fukuda, Yokohama-shi (JP); Teruo Koyanagi, Yamato-shi (JP); Hiroyasu Ohsaki, Yokohama-shi (JP); Yohsuke ozawa, Fujisawa-shi (JP)

Correspondence Address: IBM CORPORATION, T.J. WATSON RESEARCH CENTER, P.O. BOX 218, YORKTOWN HEIGHTS, NY, 10598, US

(21) Appl. No.: 12/432,032

(22) Filed: Apr. 29, 2009

(30) Foreign Application Priority Data
Apr. 30, 2008 (JP) 2008-118099

(51) Int. Cl. G06F 17/30

(52) U.S. Cl. 707/203; 707/E17.007

(57) ABSTRACT

A method and system for maintaining consistency between a view of a virtual table and the database. The method includes: First, selecting a discard candidate instance from a discard candidate list table in accordance with an LRU algorithm if it is judged that there is less free space for adding an instance. Then, judging whether a revision wait flag is on for the discard candidate instance. If it is judged that the revision wait flag is on, deleting the discard candidate instance from the discard candidate list table. If it is judged that the revision wait flag is not on, deleting the discard candidate instance from the instance pool and adding the instance to the instance pool. Lastly, adding the requested instance to the instance pool if it is judged that there is enough storage area.

### CROSS-REFERENCE TO RELATED APPLICATIONS

This application claims priority under 35 U.S.C. §119 from Japanese Patent Application No. 2008-118099 filed Apr. 30, 2008, the entire contents of which are incorporated herein by reference.

### BACKGROUND OF THE INVENTION

1. Field of the Invention

The present invention relates to maintaining consistency between a view of a virtual table and a database, wherein the contents of the virtual table are defined by the result of a retrieval query sentence to the database.

2. Description of Related Art

A technique for efficiently performing query processing to a database is a method using a view (e.g., materialized view) of a virtual table. The view is a virtual table of which the contents are defined by the result of the retrieval query sentence to the database. By creating this table beforehand, it is possible to avoid directly accessing the database to make a retrieval process for the same kind of query sentence from an application server.

On the other hand, as a method for efficiently performing an update process for the database, there is a batch update. This method includes accumulating a plurality of data update operation sentences from the application server, organizing them into a single group at a fixed interval or for every data size, and sending it to the database for processing. Generally, when data is sent or written to a disk, the processing efficiency is optimized by keeping a fixed data size or a processing interval. Accordingly, if the fixed data size or processing interval is kept by the batch update, the communication between the application server and the database is optimized, whereby the system performance is greatly improved.

However, when there is a retrieval query request for the latest data set from the application server to the database, the batch update must be executed at that time (forced flush) to correctly respond to the retrieval request, even if the number of update requests or the processing interval for the database does not reach a sufficient amount, whereby the performance of the batch update may not be fully drawn out.

One of the methods for solving this problem may involve holding a view on the application server, and performing maintenance for the view upon every update request to keep the view updated so that the process can be performed without sending a retrieval query request to the database. However, with this method, all the retrieval results pertinent to the batch updated records must exist on the application server, and accordingly, if the data amount is larger than the storage capacity, this method could not be used.

Published Japanese Patent Application No. 2004-280494 describes that when there is a data update request, a server cache is searched and the data burst server cache is updated every time, whereby the update process request for the database frequently occurs.

A hardware-implemented caching mechanism for a central processing unit (CPU) is memory access caching, in which there is still a directory for solving the address similar to the view, but a complex retrieval result is not cached, and there is no mechanism for maintenance or the like which entails double processing. Further, even in the case where a write back mechanism is provided, it is unnecessary to hold the previous update as a batch log to generate an update process instruction, apart from an instance pool, because only the final result is written into the cache. Accordingly, it is not possible to obtain a solution to the problems specific to the application server from the configuration of the CPU.

### SUMMARY OF THE INVENTION

In order to solve the above problem, the present invention provides a method and apparatus for managing a view having a virtual table for a database.

The method includes the following steps: (1) receiving a request to add an instance of record data to an instance pool of the view, (2) judging whether there is a free space for adding the instance in a storage area of the instance pool, (3) selecting a discard candidate instance from a discard candidate list table in accordance with an Least Recently Used (LRU) algorithm if it is judged that there is less free space than needed for adding the instance, (4) judging whether a revision wait flag is on for the discard candidate instance in the discard candidate list table, (5) deleting the discard candidate instance from the discard candidate list table if it is judged that the revision wait flag is on, (6) deleting the discard candidate instance from the instance pool and adding the instance to the instance pool if it is judged that the revision wait flag is not on, and (7) adding the requested instance to the instance pool if it is judged that there is enough storage area.

By preferentially holding the latest dataset or most recently accessed dataset in the view, even if the memory is not enough for the data amount of the retrieval result, it is possible to respond to a retrieval query without performing the batch update for the database at that time when there is a retrieval query request for the latest dataset.

Though the summary of the invention has been described above as the method, the invention also provides a system for managing a view having a virtual table for a database and a computer program product tangibly embodying computer readable instructions for causing a computer to execute the steps of the above method.

### BRIEF DESCRIPTION OF THE DRAWINGS

FIG. 1 is a schematic high level view for a system having a virtual table for a view of which the contents are defined by the retrieval result of a retrieval query to an application server;

FIG. 2 is a high level view conceptually showing the configuration and process of the invention;

FIG. 3 shows a processing flow in searching a view pool and an instance pool;

FIG. 4 is a view conceptually showing the operation of retrieval query;

FIG. 5 shows a processing flow for adding an instance to the view pool and the instance pool;

FIG. 6 is a view conceptually showing an update request process for the view pool;

FIG. 7 illustrates a batch update method for reflecting the update of instance to the database;

FIG. 8 illustrates a functional block diagram of the system, put in order; and

FIG. 9 illustrates a discard candidate list table.

### DETAILED DESCRIPTION OF THE PREFERRED EMBODIMENTS

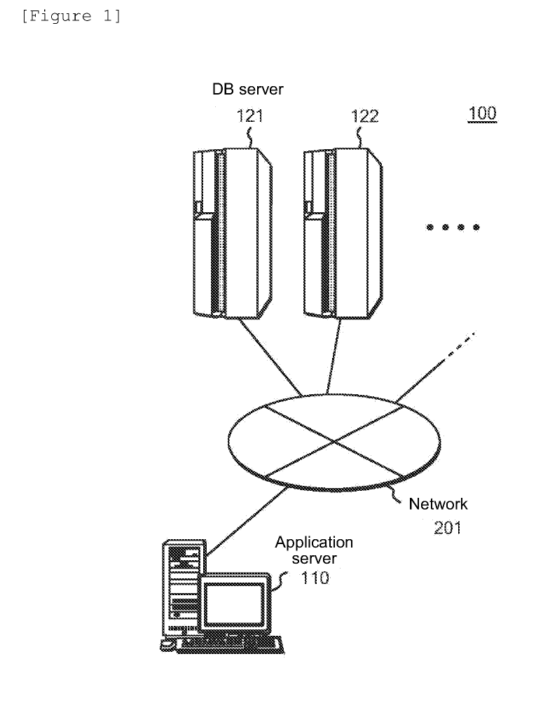

FIG. 1 is a schematic high level view for a system 100 having a virtual table for a view of which the contents are defined by the retrieval result for a retrieval query from an application server according to the present invention. The record data in the virtual table for the view is created based on data in a database. The database (DB) servers 121 and 122 contain the databases. In the figure, there is a plurality of DB servers, but in other embodiments there may be only one DB server. The DB server is connected to the application server 110 via a network 101. Typically, the highest processing efficiency is attained in the form in which the application server 110 includes a cache having the virtual table including a view pool and an instance pool, but in other embodiments another server may have this cache.

The application server 110 issues a retrieval request to the database (DB server). In practice, first, an instance ID is retrieved from the view pool by a retrieval key to check if there is a corresponding retrieval result. If there is a corresponding instance ID, record data with the corresponding instance ID is returned as the response from the instance pool, or if there is no corresponding instance ID, the DB server is directly searched. The retrieval result of the DB server is accumulated in the view pool and the instance pool. Also, when there is an update process from the application server 110, the view pool and the instance pool are updated, a write instruction into the database (DB server) is accumulated as a batch process, and the batch process is performed for the database in accordance with a predetermined rule.

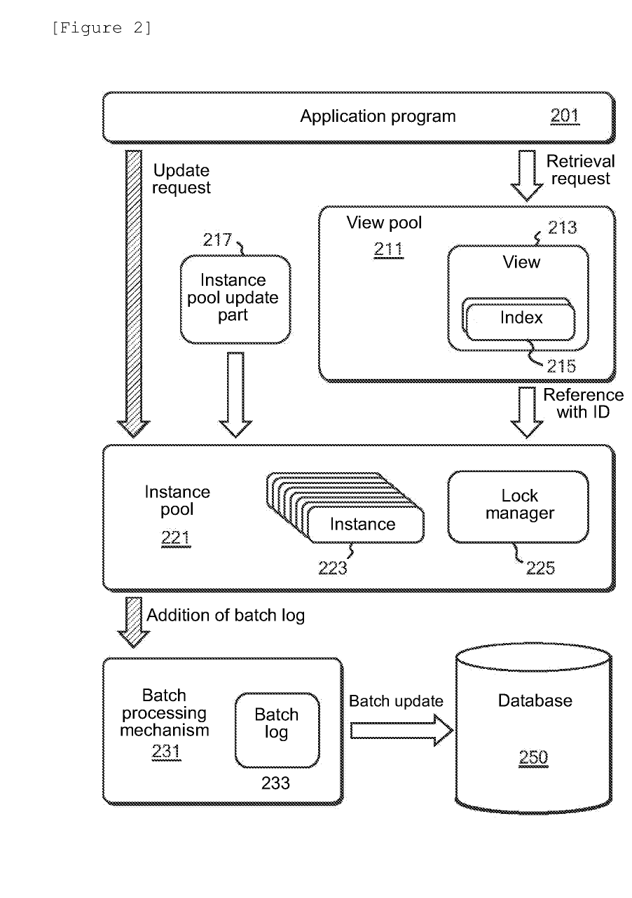

FIG. 2 is a high level view conceptually showing the configuration and process of the invention. An application program 201, a view pool 211, an instance pool 221 and a batch processing mechanism 231 are preferably on the application server, but may be distributed over other servers. Further, the database 250 is in the DB server, but may be on the same server or placed in the distributed server environment. Herein, the retrieval result is held on the application server, and the view pool 211 having the retrieval key and the instance ID and the instance pool 221 holding the entity of record referred to by the retrieval result are provided.

The application program 201 sends an update request and a retrieval request to the database 250, but actually sends them to the view pool 211 and the instance pool 221. The view pool 211 includes a view 213 having an index 215 containing a retrieval key. The index 215 also includes the instance ID. An instance pool update part 217 adds or deletes the instance to or from the instance pool 221, as needed. The instance pool 221 has an instance 223 and a lock manager 225. The instance 223 may have a lock state flag and a revision wait flag in addition to data that is a part of the database record. The batch processing mechanism 231 holds the update request as a batch log 233, and performs a batch update process for the database 250 in accordance with a predetermined rule.

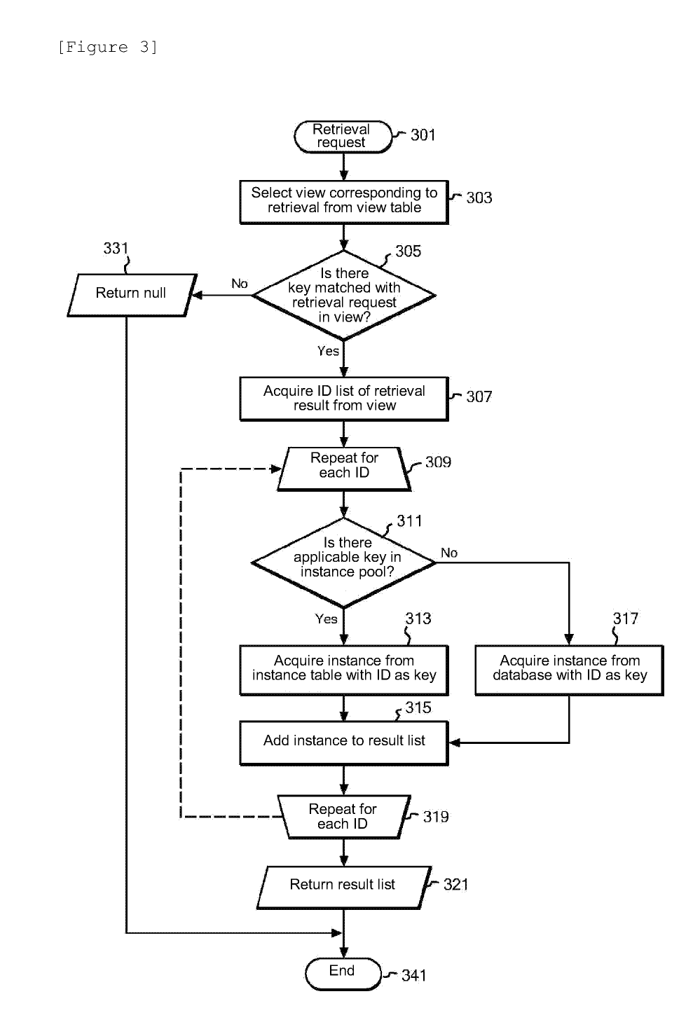

FIG. 3 illustrates a processing flow in searching the view pool and the instance pool. At step 301, a retrieval request is issued from the application program, and the flow starts. At step 303, it is checked whether the retrieval result corresponding to the retrieval query request is included in the view pool. At step 305, it is judged whether a list of ID indicating the entity of the retrieval result exists in the view. If it is judged at step 305 that the ID corresponding to the retrieval key does not exist (No), the operation goes to step 331 to return null. On the other hand if it is judged at step 305 that the ID corresponding to the retrieval key exists (Yes), the operation advances to step 307. At step 307, the corresponding ID list of the retrieval result is acquired from the view pool. In the following, the processing from step 309 to step 319 is repeated for each ID.

At step 311, it is judged whether the applicable key exists in the instance pool. If it is judged at step 311 that the instance of the applicable key does exist, then at step 313, the instance is acquired from the instance table in the instance pool with the applicable ID as the key. At step 315, the ID of the acquired instance is added to the retrieval result list to be sent back to the application program. On the other hand if it is judged at step 311 that the instance of the applicable key does not exist in the instance pool, then at step 317, the instance is acquired from the database with the ID as the key. Thereafter, the operation advances to step 315, where the ID of the acquired instance is added to the retrieval result list. If the acquisition of the instance is not ended for each ID at step 319, the operation returns to step 309. If the acquisition of the instance is ended for each ID, the operation advances to step 321. At step 321, the result list containing the instances is sent back to the application server. At step 341, the process of this flow is ended.

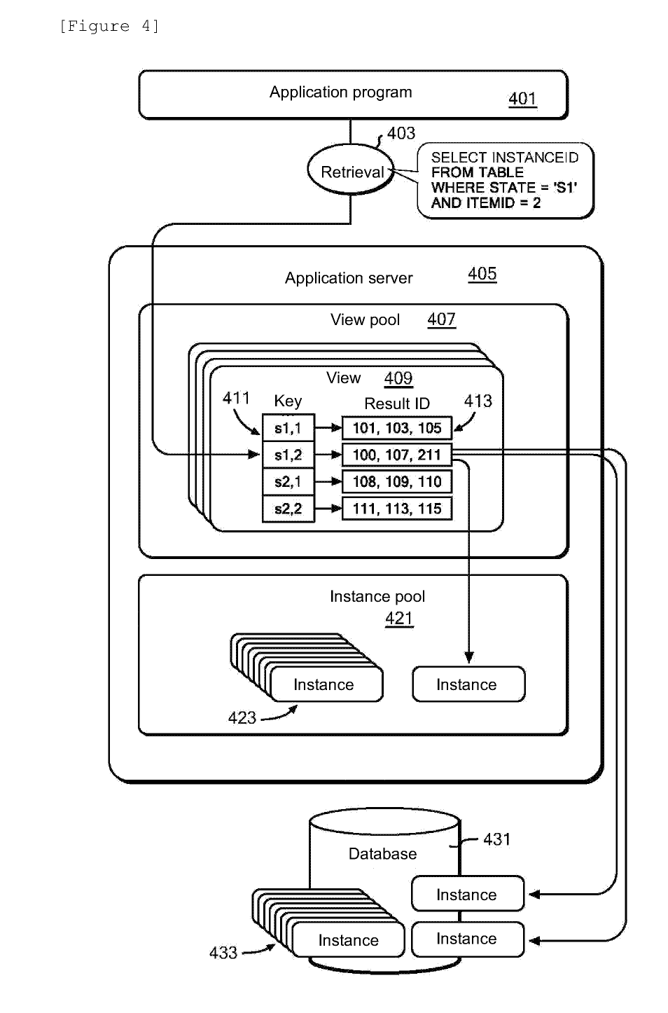

FIG. 4 is a view conceptually showing the operation in making the retrieval query. The application program originates a retrieval query sentence 403 to an application server 405. Herein, a conditional part (retrieval key) of the query sentence is (s1,2) in WHERE clause. With this key (s1,2), a key 411 contained in each view 409 within a view pool 407 is retrieved. Herein, an instance ID 413 that is the retrieval result corresponding to the key (s1,2) is (100, 107, 211). With this ID, first, an instance 423 within an instance pool 421 is retrieved. If the applicable instance exists in the instance pool, the entity of record data for the instance is acquired, and returned as the retrieval result to the application program. If the applicable instance does not exist in the instance pool 421, the instance in a database 431 is directly retrieved to acquire the entity of data, which is returned as the retrieval result to the application program.

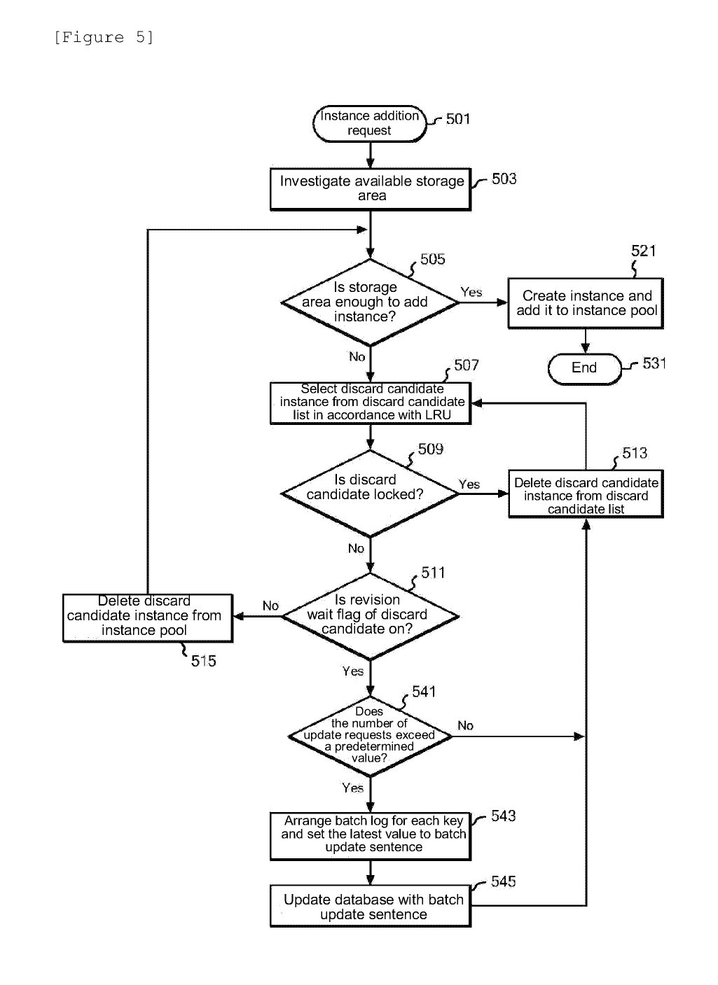

FIG. 5 illustrates a processing flow for adding the instance to the view pool and the instance pool. At step 501, the process starts. Step 501 is triggered upon receiving an instance addition request. For example, step 501 is triggered upon retrieving the instance inexistent in the instance pool from the database. At step 503, it is checked whether there is available storage area to add the instance. At step 505, it is judged whether the storage area for adding the instance is enough. If it is judged that the storage area is enough (Yes) at step 505, the operation goes to step 521. At step 521, the instance is created, and added to the instance pool. If this process is followed, the processing flow is ended at step 531. If any other instance addition request remains, the process is repeated from step 501. On the other hand if it is judged that the storage area is not enough (No) at step 505, the operation advances to step 507, where the instance to be discarded is selected from the discard candidate list of instance in accordance with an LRU (Least Recently Used) algorithm. This is performed to discard the least used instance.

At step 509, it is judged whether the discard candidate instance is locked. If it is judged that the discard candidate instance is locked (Yes) at step 509, the discard candidate instance is deleted from the discard candidate list at step 513, and the operation returns to step 507. When the instance is locked, it is meant that the instance is accessed from another. On the other hand, if it is judged that the discard candidate instance is not locked (No) at step 509, the operation advances to step 511.

At step 511, it is judged whether the revision wait flag for the discard candidate instance is on. If it is judged at step 511 that the revision wait flag is on, the operation advances to step 541, where it is judged whether the number of update requests (batch log) for the batch processing mechanism exceeds a predetermined number. If it is judged at step 541 that the predetermined number is exceeded (Yes), the operation advances to step 543, where the batch log for each key is collected and arranged, and the newest (latest) data value is set to the batch update sentence (as will be detailed later). At step 545, the batch processing mechanism actually updates the database with the batch update sentence. The operation goes to step 513, where the applicable instance is deleted from the discard candidate list. If it is judged at step 541 that the predetermined number is not exceeded (No), the operation goes to step 513, where the applicable instance is deleted from the discard candidate list. The processing from step 541 to step 545 is performed to reflect the update content to the database through the batch process because there may be a number of instances where the revision wait flag is on, however, these steps may not be necessarily performed. The applicable instance is deleted from the discard candidate list at step 513 because, for the instance where the revision wait flag is on, the update contents are not reflected to the database, and the contents of the instance pool are newest, whereby it is required to prevent the deletion from the instance pool.

If it is judged at step 511 that the revision wait flag is not on, the operation goes to step 515, where the discard candidate instance is deleted from the instance pool. Again, to add the instance, the operation returns to step 505. If it is judged that the storage area is enough (Yes), the operation goes to step 521, where the instance is created and added to the instance pool. On the other hand, if it is judged that the storage area is not enough (No), the processing from step 507 to step 515 is repeated. The flow of FIG. 5 is performed if the applicable instance does not exist in the instance pool with a retrieval sentence and an update sentence from the application server.

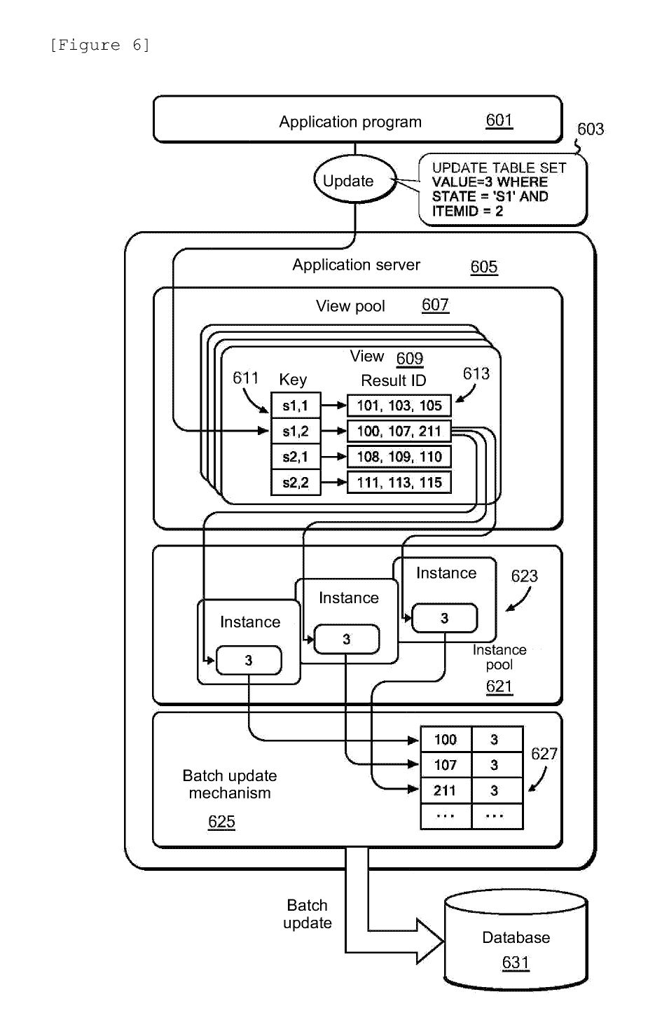

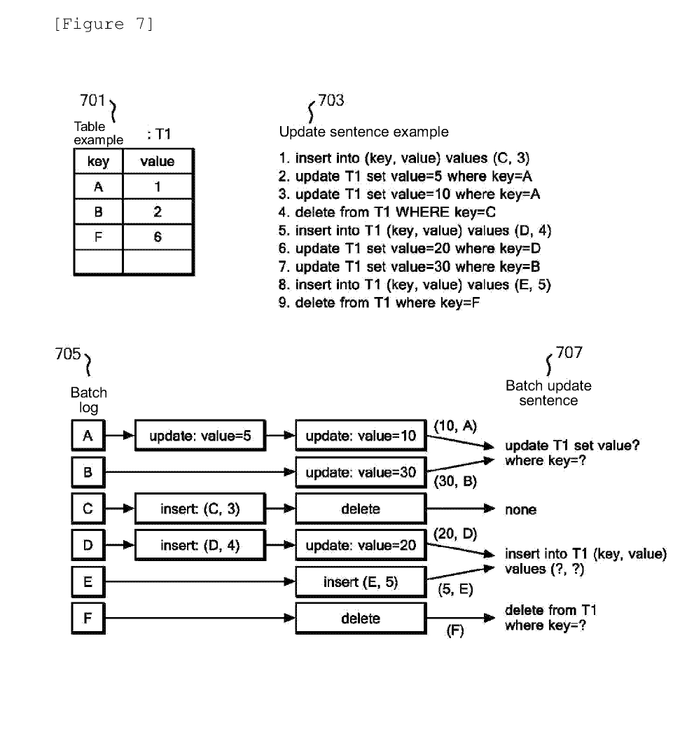

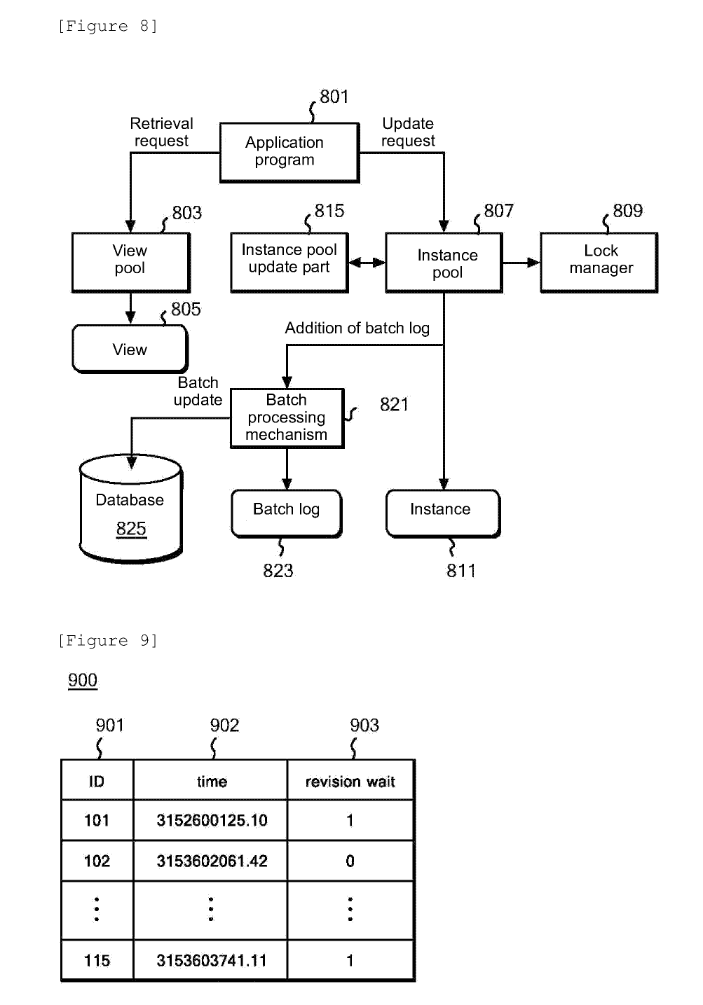

FIG. 6 is a view conceptually showing an update request process for the view pool. The application program originates an update sentence 603 to the application server 605. Herein, the key is a conditional part of the update sentence, that is, (s1,2) in WHERE clause. With this key (s1,2), a key 611 contained in each view 609 within a view pool 607 is retrieved. Herein, a result ID 613 corresponding to the key (s1,2) is (100, 107, 211). The instance 623 is retrieved from an instance pool 621 with this ID as the key, and the instance is retrieved from a database 631, whereby the instance is updated to Value=3. When the instance in the instance pool is updated, the lock for the instance is acquired to prevent contention. To acquire the lock, a queue (not shown) of a lock manager is entered.

The data after update is written into the instance 623 of the instance pool 621. This update request is passed to a batch processing mechanism 625, and the update request is added to a batch update table (batch log) 627. The revision wait flag of the instance is set. If the transaction is ended, the lock is released. And this batch update request is reflected to the database 631 at a given time (e.g., periodically, or after a certain amount of update requests are accumulated).

FIG. 7 illustrates a batch update method for reflecting the update of instance to the database. As an example, an update process for a table T1 (701) in the database is taken. An example of update sentences accumulated for the instance is shown at 703. Reference numeral 705 denotes a batch log. The batch log is arranged for each record (key), the latest (newest) value is set, and a batch update sentence (707) for actually updating the database is created. For example, with key=A, the record is updated to value=5 and further to value=10. In this case, for the batch update sentence at 707 prepared for each pattern, the value is set to (key, value)=(10,A), and the database is updated.

FIG. 8 illustrates a functional block diagram of the system, put in order. This system comprises an application program 801, a view pool 803, a view 805, an instance pool 807, a lock manager 809, an instance 811, an instance pool update part 815, a batch processing mechanism 821, a batch log 823, and a database 825. The instance pool update part 815 performs mainly the process flow of FIG. 5. The other parts have been already described above, and are not described in detail here. It will be apparent to a person skilled in the art that the block diagram may be represented by functional blocks other than these functional blocks by integrating or subdividing each function.

FIG. 9 illustrates a discard candidate list table 900. Reference numeral 901 denotes a discard candidate instance ID. Reference numeral 902 denotes the final access time to the instance. In the LRU algorithm, the instance is selected in order from the instance ID having the smallest time value. Reference numeral 903 denotes a revision wait flag. When this flag is 1, it is meant that the update contents of instance are not reflected to the database. Each column of the discard candidate list table 900 is represented to be contained in one table, but actually may not exist in one table. For example, the instance in the instance pool may have the revision wait flag.

From the above description, it can be easily understood that an information processing apparatus suitable for realizing the system according to the embodiment of the invention may be implemented in an ordinary personal computer, a workstation, or a main frame, or a combination thereof. These components are illustrative, and all the components may not be the essential components of the invention.

It will be apparent to a person skilled in the art that various changes in each hardware component of the information processing apparatus for use in the embodiment of the invention may be made by combining a plurality of machines, or distributing the functions over them. These changes should be naturally encompassed within the concept of the invention.

The system according to the embodiment of the invention can employ an operating system supporting a GUI (graphical user interface) multi-window environment such as Windows® operating system provided by Microsoft Inc., Mac OS® provided by Apple Computer Inc., UNIX® system having an X Window System (e.g., AIX® provided by International Business Machines Corporation).

From the above, it can be understood that the system for use in the embodiment of the invention may not be limited to the specific operating system environment.

Also, the invention may be implemented as hardware, software or a combination of hardware and software. As a typical example by the combination of hardware and software, a data processing system having a predetermined program is conceived. In such a case, the predetermined program is loaded into the data processing system and executed, whereby the program controls the data processing system to perform the processing according to the invention. This program is composed of an instruction group that can be represented by any language, code and notation. Such instruction group causes the system to perform the specific function directly, or after making any one or both of (i) conversion into another language, code and notation and (ii) copy to another medium.

The invention encompasses not only such program itself but also the medium storing the program. The program for performing the functions of the invention can be stored in any computer readable storage medium such as a flexible disk, MO, CD-ROM, DVD, hard disk drive, ROM, MRAM or RAM. Such program may be downloaded from another data processing system connected via the communication line or copied from another storage medium for storage into the storage medium. Also, such program may be compressed or divided into plural, and stored in a single medium or plural storage media. It should be noted that a program product for carrying out the invention may be naturally provided in various forms.

According to the embodiment of the invention, it is understood that even if the memory is not enough for the data amount of retrieval result, the latest dataset or most recently accessed dataset is preferentially held in the view, whereby even if there is a retrieval query request for the latest dataset, it is possible to respond to the retrieval query without performing the batch update for the database at that time.

It will be apparent to a person skilled in the art that various variations or modifications may be made to the above embodiment. It should be noted that such variations or modifications are included in the technical scope of the invention.

1. A method for managing a view having a virtual table for a database, said method comprising the steps of:
receiving a request to add an instance of record data to an instance pool of said view;
judging whether there is a free space for adding said instance in a storage area of said instance pool;
selecting a discard candidate instance from a discard candidate list table in accordance with a Least Recently Used (LRU) algorithm if it is judged that there is less free space than needed for adding said instance;
judging whether a revision wait flag is on for said discard candidate instance;
deleting said discard candidate instance from said discard candidate list table if it is judged that said revision wait flag is on;
deleting said discard candidate instance from said instance pool and adding said instance to said instance pool if it is judged that said revision wait flag is not on; and
adding said requested instance to said instance pool if it is judged that there is enough of said storage area.

2. The method according to claim 1, further comprising the steps of:
judging whether said discard candidate instance is locked; and
deleting said discard candidate instance from said discard candidate list if it is judged that said discard candidate instance is locked.

3. The method according to claim 1, further comprising the step of:
judging whether a number of update requests in a batch process for reflecting an update to said database exceeds a predetermined number if it is judged that a revision wait flag is on in said discard candidate instance;
arranging and setting said update requests to a batch update sentence if it is judged that said predetermined number is exceeded; and
updating said database with said batch update sentence.

4. The method according to claim 1, wherein said instance in said instance pool has said revision wait flag and a lock state flag.

5. The method according to claim 1, wherein all of said steps are performed if said instance does not exist in said instance pool.

6. The method according to claim 1, further comprising the step of:
acquiring an ID of said instance from a view pool containing a retrieval key of said view; and
retrieving a record of said instance corresponding to said ID from said instance pool.

7. A computer program product tangibly embodying computer readable instructions which, when implemented, causes a computer to execute the steps of:
receiving a request to add an instance of record data to an instance pool of said view;
judging whether there is a free space for adding said instance in a storage area of said instance pool;
selecting a discard candidate instance from a discard candidate list table in accordance with a Least Recently Used (LRU) algorithm if it is judged that there is less free space than needed for adding said instance;
judging whether a revision wait flag is on for said discard candidate instance;
deleting said discard candidate instance from said discard candidate list table if it is judged that said revision wait flag is on;
deleting said discard candidate instance from said instance pool and adding said instance to said instance pool if it is judged that said revision wait flag is not on; and
adding said requested instance to said instance pool if it is judged that there is enough of said storage area.

8. A system for managing a view having a virtual table for a database, said system comprising:
a view pool containing a retrieval key;
an instance pool including an instance of at least one part of record data in said database;
a batch processing part for reflecting said update of a record held in said instance pool to said database; and
means for receiving a request for adding an instance of record data to said instance pool of said view;
means for judging whether there is a free space for adding said instance in a storage area of said instance pool;
means for selecting a discard candidate instance from a discard candidate list table in accordance with an Least Recently Used (LRU) algorithm if it is judged that there is less free space for adding said instance;
means for judging whether a revision wait flag is on for said discard candidate instance;
means for deleting said discard candidate instance from said discard candidate list table if it is judged that said revision wait flag is on;
means for deleting said discard candidate instance from said instance pool and adding said instance to said instance pool if it is judged that said revision wait flag is not on; and
means for adding said requested instance to said instance pool if it is judged that there is enough said storage area.

9. The system according to claim 8, further comprising:
means for judging whether said discard candidate instance is locked; and
means for deleting said discard candidate instance from said discard candidate list if it is judged that said discard candidate instance is locked.

10. The system according to claim 8, further comprising:
means for judging whether a number of update requests in a batch process for reflecting the update to the database exceeds a predetermined number if it is judged that the revision wait flag is on for said discard candidate instance; and
wherein said batch processing part arranges and sets said update requests to a batch update sentence and updates the database with the batch update sentence if it is judged that said predetermined number is exceeded.

11. The system according to claim 8, wherein said instance in said instance pool has a revision wait flag and a lock state flag.

12. The system according to claim 8, further comprising:
means for acquiring an ID of said instance from said view pool; and
means for retrieving a record of said instance corresponding to said ID from said instance pool.
